(19) United States
(12) Patent Application Publication
(10) Pub. No.: US 2013/0152181 A1
(43) Pub. Date: Jun. 13, 2013

(54) PORTAL BASED CASE STATUS MANAGEMENT

(71) Applicant: BRIAN GREGORY EILER, Theodore, AL (US)

(72) Inventor: BRIAN GREGORY EILER, Theodore, AL (US)

(73) Assignee: International Business Machines Corporation, Armonk, NY (US)

(21) Appl. No.: 13/313,942

(22) Filed: Dec. 7, 2011

(51) Int. Cl. H04L 9/32; G06F 7/00

(52) U.S. Cl. 726/7; 707/687

(57) ABSTRACT

Illustrative embodiments include a method, system, and computer program product for providing a current status of an update to a data record. A computer receives, from a portal in a backend application, a request for status of a previous request to perform the update to the data record. The computer determines a previously reported status from a previously completed processing operation on the data record in a workflow used for processing the previous request. The computer further determines a status of a presently incomplete processing operation on the data record in the workflow used for processing the previous request. The computer adding the previously reported status and the status of the presently incomplete processing operation to a status report, forming the current status. The computer transmits a response including the current status.

### TECHNICAL FIELD

The present invention relates generally to a method, system, and computer program product for data management. Particularly, the present invention relates to a method, system, and computer program product for portal based case status management.

### BACKGROUND

A web portal (portal) is a web-based manner of presenting information from a diverse set of applications. For example, a business enterprise can implement a portal on the business's intranet for the business's employees to perform business related functions. A portal application or function (portlet) may allow an employee to login to a development server to manipulate development code libraries. For example, a financial portlet may allow an employee to submit time records for project management.

A portal may or may not require user authentication before allowing a user access to the portal functions. For example, a public library's website may be a portal that may allow any user to perform at least some functions, such as a catalog search, before the user has to provide identifying information.

### SUMMARY

The illustrative embodiments provide a method, system, and computer program product for portal based case status management. In at least one embodiment, a method for providing a current status of an update to a data record is provided. The method includes a computer receiving, from a portal in a backend application, a request for status of a previous request to perform the update to the data record. The method further includes the computer determining a previously reported status from a previously completed processing operation on the data record in a workflow used for processing the previous request. The method further includes the computer further determining a status of a presently incomplete processing operation on the data record in the workflow used for processing the previous request. The method further includes the computer adding the previously reported status and the status of the presently incomplete processing operation to a status report, forming the current status. The method further includes the computer transmitting a response including the current status.

In at least one embodiment, a computer program product for providing a current status of an update to a data record is provided. The computer program product includes one or more computer-readable tangible storage devices. The computer program product further includes program instructions, stored on at least one of the one or more storage devices, to receive, from a portal in a backend application, a request for status of a previous request to perform the update to the data record. The computer program product further includes program instructions, stored on at least one of the one or more storage devices, to determine a previously reported status from a previously completed processing operation on the data record in a workflow used for processing the previous request. The computer program product further includes program instructions, stored on at least one of the one or more storage devices, to further determine a status of a presently incomplete processing operation on the data record in the workflow used for processing the previous request. The computer program product further includes program instructions, stored on at least one of the one or more storage devices, to add the previously reported status and the status of the presently incomplete processing operation to a status report, forming the current status. The computer program product further includes program instructions, stored on at least one of the one or more storage devices, to transmit a response including the current status.

In at least one embodiment, a computer system for providing a current status of an update to a data record is provided. The computer system includes one or more processors, one or more computer-readable memories and one or more computer-readable tangible storage devices. The computer system further includes program instructions, stored on at least one of the one or more storage devices for execution by at least one of the one or more processors via at least one of the one or more memories, to receive, from a portal in a backend application, a request for status of a previous request to perform the update to the data record. The computer system further includes program instructions, stored on at least one of the one or more storage devices for execution by at least one of the one or more processors via at least one of the one or more memories, to determine a previously reported status from a previously completed processing operation on the data record in a workflow used for processing the previous request. The computer system further includes program instructions, stored on at least one of the one or more storage devices for execution by at least one of the one or more processors via at least one of the one or more memories, to further determine a status of a presently incomplete processing operation on the data record in the workflow used for processing the previous request. The computer system further includes program instructions, stored on at least one of the one or more storage devices for execution by at least one of the one or more processors via at least one of the one or more memories, to add the previously reported status and the status of the presently incomplete processing operation to a status report, forming the current status. The computer system further includes program instructions, stored on at least one of the one or more storage devices for execution by at least one of the one or more processors via at least one of the one or more memories, to transmit a response including the current status.

### BRIEF DESCRIPTION OF THE SEVERAL VIEWS OF THE DRAWINGS

The novel features believed characteristic of the invention are set forth in the appended claims. The invention itself, however, as well as a preferred mode of use, further objectives and advantages thereof, will best be understood by reference to the following detailed description of illustrative embodiments when read in conjunction with the accompanying drawings, wherein:

FIG. 1 depicts a pictorial representation of a network of data processing systems in which illustrative embodiments may be implemented;

FIG. 2 depicts a block diagram of a data processing system in which illustrative embodiments may be implemented;

FIG. 3 depicts a block diagram of a generalized portal configuration for employee record update in accordance with an illustrative embodiment;

FIG. 4 depicts a block diagram of an example configuration of an improved backend application for providing current case status on demand in accordance with an illustrative embodiment;

FIG. 5 depicts a flowchart of an example process of providing current status of a pending employee record update request in accordance with an illustrative embodiment; and

FIG. 6 depicts a flowchart of an example process for providing a current status of an employee record update in accordance with an illustrative embodiment.

### DETAILED DESCRIPTION

The illustrative embodiments recognize that certain applications available via a portal may require different control mechanisms from other applications in the portal. For example, a development portlet may only require verification that a user belongs to a particular development team for the user to be able to checkout a code file. A human resource (HR) portlet may be significantly more restrictive in granting access to HR data, such as employee records.

For example, the illustrative embodiments recognize that in many cases, a third party service provider (service provider) may provide HR functions. The service provider may provide the HR functions through a common instance of a backend application, such as Siebel®, or PeopleSoft®. Siebel and PeopleSoft are registered trademarks of Oracle Corporation in the United States and other countries.

The illustrative embodiments recognize that in these and other configurations, a backend application's functions are presented via different user interfaces, including portals. Furthermore, the illustrative embodiments recognize that a backend application may employ workflows according to the business processes related to the functions offered from the backend application. For example, when a single instance of a backend HR application hosts employee records of several client organizations, the backend application may employ different workflow processes for handling similar changes to the employee records of different organizations.

A portal user may be able to access the user's employee records managed by a backend application. The illustrative embodiments recognize, however, that unlike other portal components (portlets), employee records manipulation from a portal is an activity that is not completely self-executed. For example, while a user may be able to self-subscribe to a development server via a corporate portal, the user may not be able to modify the user's own employee record via an HR portlet on the portal.

Within the scope of this disclosure, an employee record may include information about users, members, workers, or participants in a business enterprise, not limited only to employees, but also including contractors, temporary workers, consultants, on-loan specialists, or any other type of workers that may contribute to the business's functions. Within the scope of the disclosure, such information about such workers includes but is not limited to the data typically maintained by a human resource organization. For example, an employee record within the scope of the disclosure may include one or more of hiring data, salary and benefits data, performance and other evaluations related data, legal data, and demographic data about an individual working for, at, or on-behalf of a business entity.

The illustrative embodiments recognize that for certain modifications to a user's employee records, presently, a user has to seek assistance from a business function unit. For example, a contact center may be a help-desk or similar business function unit that may receive a request from an individual to modify or update an employee record. The illustrative embodiments recognize that the business function unit typically opens a case or incident under which the request is tracked, such as using a backend application's workflow.

The illustrative embodiments recognize that unlike some other requests, a request to update an employee record often leaves the requestor without current status information about the processing of the request. Presently, the requestor is notified of the final status of success or failure of the requested update. The illustrative embodiments recognize that the lack of visibility into the processing of employee record update request is problematic. The illustrative embodiments also recognize that a summary status of the success or failure of the requested update is also insufficient for many purposes.

For example, a job function change for an employee may be dependent upon an employee record update, and the employee may normally be permitted to begin the new job function if at least a part of the employee record update has been performed, even if the update has not been completed. However, presently, status information about a partially completed employee record update process is not available to a person or application requesting the update.

The illustrative embodiments used to describe the invention generally address and solve the above-described problems and other problems related to statuses of employee record update cases. The illustrative embodiments provide a method, system, and computer program product for portal based case update management.

Generally, an embodiment of the invention provides a method for providing on-demand status of a requested employee record update. An embodiment describes a method by which a user or an application can request, via a portal, status of a pending employee record update at any point in the update process, and receive a current status information regardless of when a backend application's business process workflow previously reported status. Thus, the illustrative embodiments provide a method of obtaining via a portal a current status report of an employee record update without needing the knowledge of a backend processing's workflow.

The illustrative embodiments are described with respect to certain data and data structures only as examples. Such descriptions are not intended to be limiting on the invention. For example, an illustrative embodiment described with respect to an employee record can be implemented with similarly purposed data, such as financial records, within the scope of the illustrative embodiments.

Furthermore, the illustrative embodiments may be implemented with respect to any type of data, data source, or access to a data source over a data network. Any type of data application or storage device may provide the data, such as data for an application data packet or historical state information data, to an embodiment of the invention, either locally at a data processing system or over a data network, within the scope of the invention.

The illustrative embodiments are further described with respect to certain applications only as examples. Such descriptions are not intended to be limiting on the invention. For example, an embodiment described with respect to Siebel can be implemented using another application or database within the scope of the illustrative embodiments.

An embodiment of the invention may be implemented with respect to any type of application, such as, for example, applications that are served, the instances of any type of server application, a platform application, a stand-alone application, an administration application, or a combination thereof. An application, including an application implementing all or part of an embodiment, may further include data objects, code objects, encapsulated instructions, application fragments, services, and other types of resources available in a data processing environment. For example, a Java® object, an Enterprise Java Bean (EJB), a servlet, or an applet may be manifestations of an application with respect to which the invention may be implemented. (Java and all Java-based trademarks and logos are trademarks or registered trademarks of Oracle Corporation and/or its affiliates).

An illustrative embodiment may be implemented in hardware, software, or a combination thereof. An illustrative embodiment may further be implemented with respect to any type of data storage resource, such as a physical or virtual data storage device, that may be available in a given data processing system configuration.

The examples in this disclosure are used only for the clarity of the description and are not limiting on the illustrative embodiments. Additional data, operations, actions, tasks, activities, and manipulations will be conceivable from this disclosure and the same are contemplated within the scope of the illustrative embodiments.

Any advantages listed herein are only examples and are not intended to be limiting on the illustrative embodiments. Additional or different advantages may be realized by specific illustrative embodiments. Furthermore, a particular illustrative embodiment may have some, all, or none of the advantages listed above.

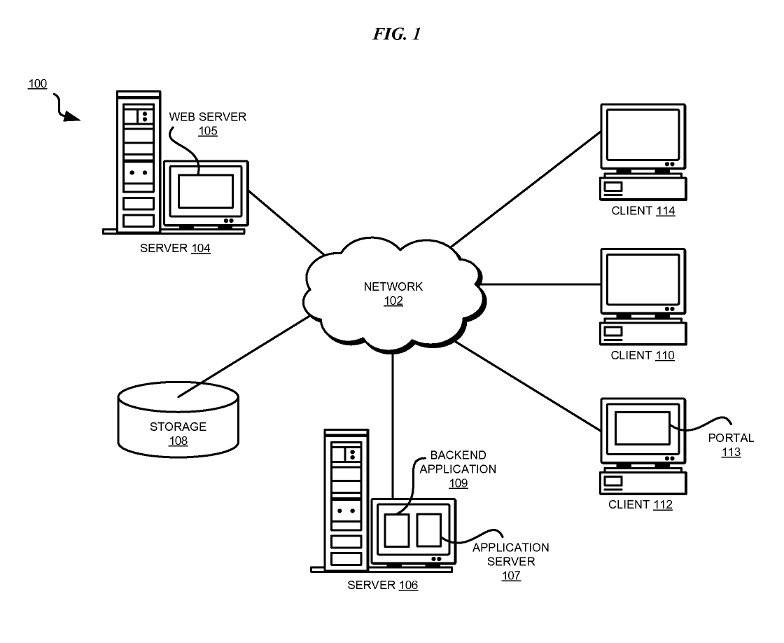

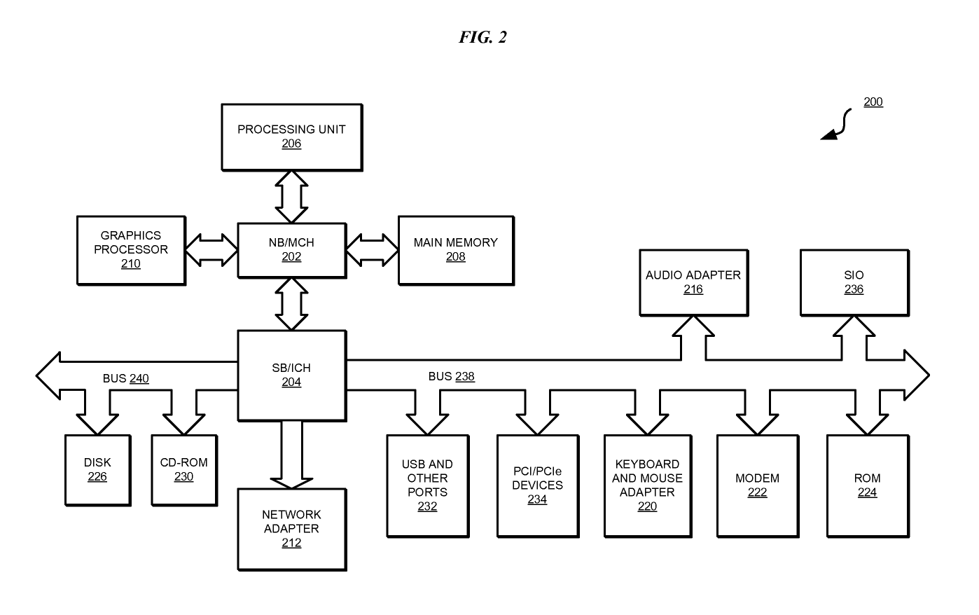

With reference to the figures and in particular with reference to FIGS. 1 and 2, these figures are example diagrams of data processing environments in which illustrative embodiments may be implemented. FIGS. 1 and 2 are only examples and are not intended to assert or imply any limitation with regard to the environments in which different embodiments may be implemented. A particular implementation may make many modifications to the depicted environments based on the following description.

FIG. 1 depicts a pictorial representation of a network of data processing systems in which illustrative embodiments may be implemented. Data processing environment 100 is a network of computers in which the illustrative embodiments may be implemented. Data processing environment 100 includes network 102. Network 102 is the medium used to provide communications links between various devices and computers connected together within data processing environment 100. Network 102 may include connections, such as wire, wireless communication links, or fiber optic cables. Server 104 and server 106 couple to network 102 along with storage unit 108. Software applications may execute on any computer in data processing environment 100.

In addition, clients 110, 112, and 114 couple to network 102. A data processing system, such as server 104 or 106, or client 110, 112, or 114 may contain data and may have software applications or software tools executing thereon.

As an example, server 104 includes web server 105, which may be used to present a portal form of user interface, such as portal 113 in client 112. Application server 107 may be one of any number of servers that participate in portal 113 presented by web server 105. Application server 107 may further interface with backend application 109 for providing particular portlet functionality via portal 113.

As an example, web server 105, application server 107, and backend application 109, according to an embodiment may each be implemented as program instructions that can be stored on at least one of one or more data storage devices and executed by at least one of one or more processors via at least one of one or more memories.

Servers 104 and 106, storage unit 108, and clients 110, 112, and 114 may couple to network 102 using wired connections, wireless communication protocols, or other suitable data connectivity. For example, a cluster typically has multiple network types, such as IP networks, direct connections of machines via packets exchange implemented by storage protocols (Fibre Channel, SCSI), serial links, and message exchange via writing and reading packets to shared storage such as a hard disk drive. For performance reasons, in sending client traffic, an IP network is given precedence. Furthermore, a given network type may not connect to all nodes in a cluster. For instance, a cluster may span machines located at two geographically distant sites. For the long distance connection, Ethernet may be the preferred connection, and within a geographical location, a direct connection may be preferable. Additionally, within a geographical location, additional non-IP networks, such as Fibre channel or serial connections may be used within the scope of the illustrative embodiments.

Clients 110, 112, and 114 may be, for example, personal computers, network computers, thin clients, or industrial control systems. In the depicted example, server 104 may provide data, such as boot files, operating system images, and applications to clients 110, 112, and 114. Clients 110, 112, and 114 may be clients to server 104 in this example. Clients 110, 112, 114, or some combination thereof, may include their own data, boot files, operating system images, and applications. Data processing environment 100 may include additional servers, clients, and other devices that are not shown.

In the depicted example, data processing environment 100 may be the Internet. Network 102 may represent a collection of networks and gateways that use the Transmission Control Protocol/Internet Protocol (TCP/IP) and other protocols to communicate with one another, and encompasses components including but not limited to IP and SAN components. At the heart of the Internet is a backbone of data communication links between major nodes or host computers, including thousands of commercial, governmental, educational, and other computer systems that route data and messages. Of course, data processing environment 100 also may be implemented as a number of different types of networks, such as for example, an intranet, a local area network (LAN), or a wide area network (WAN). FIG. 1 is intended as an example, and not as an architectural limitation for the different illustrative embodiments.

Among other uses, data processing environment 100 may be used for implementing a client-server environment in which the illustrative embodiments may be implemented. A client-server environment enables software applications and data to be distributed across a network such that an application functions by using the interactivity between a client data processing system and a server data processing system. Data processing environment 100 may also employ a service oriented architecture where interoperable software components distributed across a network may be packaged together as coherent business applications.

With reference to FIG. 2, this figure depicts a block diagram of a data processing system in which illustrative embodiments may be implemented. Data processing system 200 is an example of a computer, such as server 104, server 106, or client 112 in FIG. 1, in which computer usable program code or instructions implementing the processes of the illustrative embodiments may be located for the illustrative embodiments.

In the depicted example, data processing system 200 employs a hub architecture including North Bridge and memory controller hub (NB/MCH) 202 and south bridge and input/output (I/O) controller hub (SB/ICH) 204. Processing unit 206, main memory 208, and graphics processor 210 are coupled to north bridge and memory controller hub (NB/MCH) 202. Processing unit 206 may include one or more processors and may be implemented using one or more heterogeneous processor systems. Graphics processor 210 may be coupled to NB/MCH 202 through an accelerated graphics port (AGP) in certain implementations.

In the depicted example, local area network (LAN) adapter 212 is coupled to south bridge and I/O controller hub (SB/ICH) 204. Audio adapter 216, keyboard and mouse adapter 220, modem 222, read only memory (ROM) 224, universal serial bus (USB) and other ports 232, and PCI/PCIe devices 234 are coupled to south bridge and I/O controller hub 204 through bus 238. Hard disk drive (HDD) 226 and CD-ROM 230 are coupled to south bridge and I/O controller hub 204 through bus 240. PCI/PCIe devices 234 may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM 230 may use, for example, an integrated drive electronics (IDE) or serial advanced technology attachment (SATA) interface. A super I/O (SIO) device 236 may be coupled to south bridge and I/O controller hub (SB/ICH) 204 through bus 238.

An operating system runs on processing unit 206. The operating system coordinates and provides control of various components within data processing system 200 in FIG. 2. The operating system may be a commercially available operating system such as Microsoft® Windows® (Microsoft and Windows are trademarks of Microsoft Corporation in the United States, other countries, or both), or Linux® (Linux is a trademark of Linus Torvalds in the United States, other countries, or both). An object oriented programming system, such as the Java™ programming system, may run in conjunction with the operating system and provide calls to the operating system from Java™ programs or applications executing on data processing system 200.

Program instructions for the operating system, the object-oriented programming system, the processes of the illustrative embodiments, and applications or programs, including web server 105, application server 107, backend application 109, and portal 113, are located on one or more storage devices, such as hard disk drive 226 or CD-ROM 230, and may be loaded into a memory, such as, for example, main memory 208, read only memory 224, or one or more peripheral devices, for execution by processing unit 206. Program instructions may also be stored permanently in non-volatile memory and either loaded from there or executed in place. For example, the synthesized program according to an embodiment can be stored in non-volatile memory and loaded from there into DRAM.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. In addition, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may comprise one or more buses, such as a system bus, an I/O bus, and a PCI bus. Of course, the bus system may be implemented using any type of communications fabric or architecture that provides for a transfer of data between different components or devices attached to the fabric or architecture.

A communications unit may include one or more devices used to transmit and receive data, such as a modem or a network adapter. A memory may be, for example, main memory 208 or a cache, such as the cache found in north bridge and memory controller hub 202. A processing unit may include one or more processors or CPUs.

The depicted examples in FIGS. 1-2 and above-described examples are not meant to imply architectural limitations. For example, data processing system 200 also may be a tablet computer, laptop computer, or telephone device in addition to taking the form of a PDA.

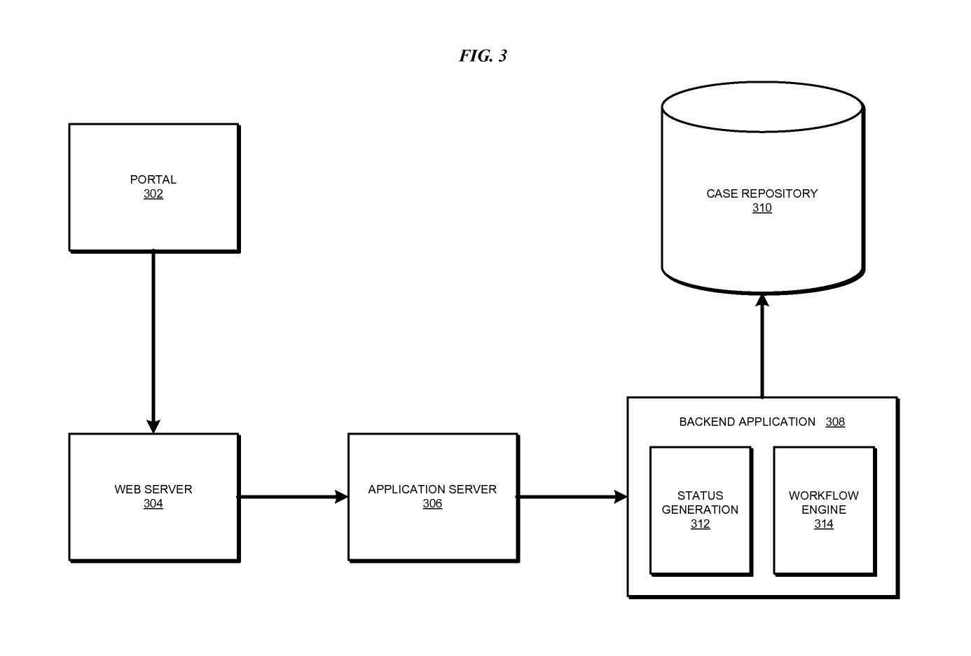

With reference to FIG. 3, this figure depicts a block diagram of a generalized portal configuration for employee record update in accordance with an illustrative embodiment. Portal 302 may be analogous to portal 113, web server 304 may be analogous to web server 105, and application server 306 may be analogous to application server 107 in FIG. 1.

Backend application 109 in FIG. 1 may be modified with an embodiment to form backend application 308. Backend application 308 manages information pertaining to employee records, and employee record updates (collectively, case data) in case repository 310. Case repository 310 may be any suitable manner of storing case data, including but not limited to a relational database.

Backend application 308 includes status generation component 312 and workflow engine 314. Status generation component 312 implements an embodiment for providing status report for a pending employee record update. Workflow engine 314 implements one or more business processes and corresponding workflows to update or otherwise manipulate employee records in case repository 310.

Typically, a workflow used by workflow engine 314 is configured in the form of a state machine, where the process of updating an employee record is accomplished by transitioning from one state to another, to a final state. Status reports about an employee record update, if available, are available only at the discrete states of the workflow. For example, during the processing of an employee record update request, in response to workflow engine 314 transitioning from one state to another, workflow engine 314 may record a status of the update request processing at case repository 310.

However, a significant amount of time may elapse between such state-wise status reports. Even if a requestor were able to request a status of the update request, the status report is likely to be the report that was last made in the update process's workflow. Status generation component 312 solves this problem by using an embodiment. Status generation component 312 operates to provide a current status in response to a request for status of a previously submitted employee record update request.

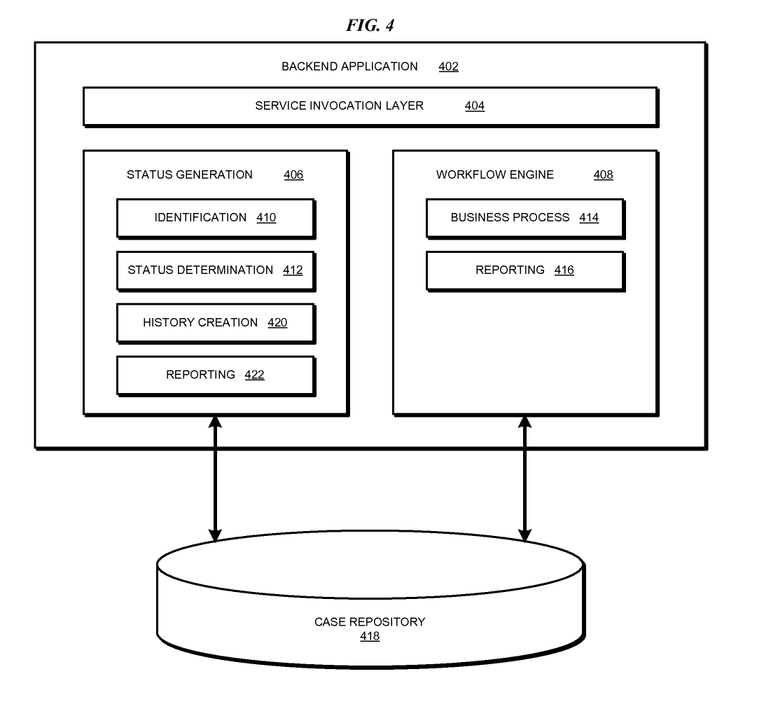

With reference to FIG. 4, this figure depicts a block diagram of an example configuration of an improved backend application for providing current case status on demand in accordance with an illustrative embodiment. Backend application 402 may be used as backend application 308 in FIG. 3.

Service invocation layer 404 is a component that offers certain functionality of backend application 402, such as a web-service that can be called from a portal to request a current status of a previously sent employee record update request. Service invocation layer 404 receives the request for current status, in response to a user or application making the request from a portal. Note that the request may be presented in any form at the portal, such as a HTTP request, SOAP request, XML transaction, MQ-series message, or any other suitable form. The request is communicated to backend application 402, such as through service invocation layer 404. In one embodiment, backend application 402 may be served from an application server, such sa application server 306 in FIG. 3, and the service invocation layer 404 may be available for invocation from the application server. In such an embodiment, a web server that receives the request, such as web server 304 in FIG. 3, can invoke certain functionality of backend application 402, such as a web service, through service invocation layer 404 made available from the application server. In another embodiment, backend application 402 and service invocation layer 404 may be accessible to the web server via a different mechanism, other than an application server. For example, the web server may call a certain functionality of backend application 402 directly. For example, when the functionality is a web service of backend application 402, the web server can invoke the web service by using a web service interface that is published in service invocation layer 404. A web service interface can be created using Web Services Description Language (WSDL).

Status generation component 406 is analogous to status generation component 312 in FIG. 3, and is described herein in further detail. Identification component 410 identifies the requestor of the request for current status received at service invocation layer 404. For example, in one embodiment, identification component 410 may authenticate a user using the user-ID and password carried in a web services request for status. In another example embodiment, identification component 410 may authenticate a user by validating a certificate presented in the web services request for status. As an example, the certificate may identify not only the user, but also the user's organization, and other attributes of the user's identity or privilege.

Status determination component 412 determines the current status of the previously presented request for employee record update. For example, workflow engine 408, which is analogous to workflow engine 314 in FIG. 3, includes business process implementation 414, which implements the states of processing an employee record update. Reporting component 416 reports the status and other information in response to business process component 414 accomplishing a step of the update process and transitions to another state in the update process. The status report produced by business process component 414 is reported in case repository 418.

Status determination component 412 collects the status information that is reported in this manner by reporting component 416. In one embodiment, status determination component 412 further interrogates business process component 414 to determine a level of update completion, such as by determining the completed portions of the state transition currently being processed for the update.

History creation component 420 may query case repository 418 to select previous cases opened by the same requestor, cases relating to the same employee record, or other similar historical information that may be helpful to the requestor. For example, in conjunction with a current status of the presently pending update request, a requestor may be able to better estimate a completion time for the update by knowing how long the process took to transition from step A to step B in a similar update of the employee record previously.

Reporting component 422 compiles the current status information, the historic information, or a combination thereof, collected in the manner described above. Reporting component 422 then prepares a suitably formatted response to be returned to the requestor's portal via service invocation layer 404.

Components 404, 406, 408, 410, 412, 414, 416, 418, 420, and 422 may each be implemented in hardware or software. For example, in one embodiment, components 404, 406, 408, 410, 412, 414, 416, 418, 420, and 422 may each be implemented as program instructions that can be stored on at least one of one or more data storage devices and executed by at least one of one or more processors via at least one of one or more memories.

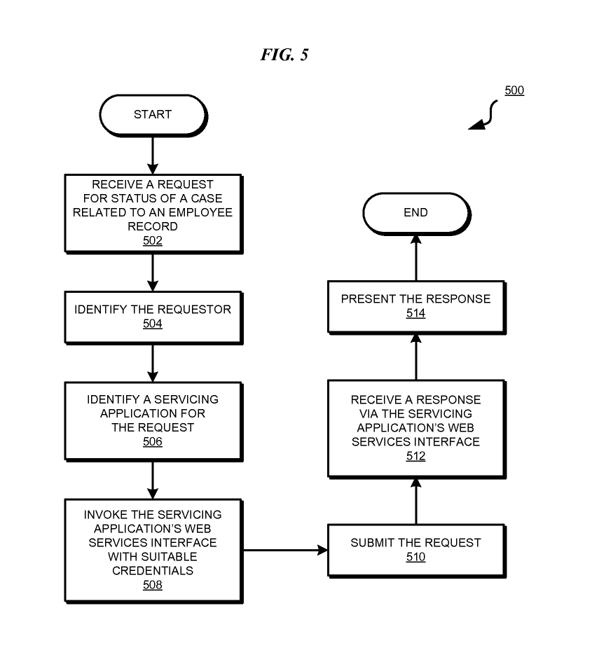

With reference to FIG. 5, this figure depicts a flowchart of an example process of providing current status of a pending employee record update request in accordance with an illustrative embodiment. Process 500 can be implemented in a web server, such as web server 304 in FIG. 3.

The web server receives a request for status of a case related to employee record, such as a previously submitted request for updating the employee record, the update being presently incomplete (block 502). For example, a requestor may submit the status request from a portal presented from a web server. The web server identifies the requestor (block 504).

The web server identifies a servicing backend application for the status request (block 506). For example, the portal may include a portlet for a backend servicing application that manages employee records, such as backend application 402 in FIG. 4.

The web server invokes the servicing backend application's web services interface using suitable credentials for the requestor (block 508). For example, the web server may call a web service of backend application 402 using service invocation layer 404 in FIG. 4, and supplying a certificate or Security Assertion Markup Language (SAML) token. The web server submits the status request through the invocation of block 508 (block 510).

The web server receives a response via the servicing backend application's web services interface (block 512). The web server presents the response, for example, via the portal from which the component received the request of block 502 (block 514). Process 500 ends thereafter.

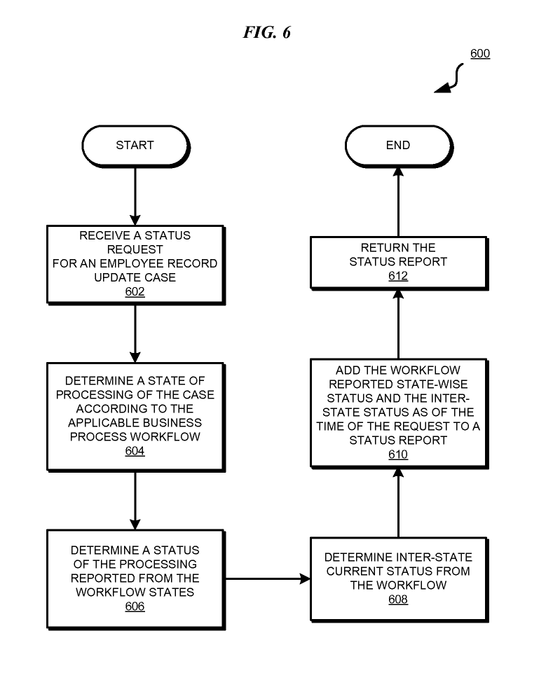

With reference to FIG. 6, this figure depicts a flowchart of an example process for providing a current status of an employee record update in accordance with an illustrative embodiment. Process 600 can be implemented in a status generation component of a backend application that manages employee records, such as status generation component 406 of backend application 402 in FIG. 4, which includes an embodiment.

The status generation component receives a request for status of a case related to employee record, such as a previously submitted request for updating the employee record, the update being incomplete at the time of receiving the request (block 602). For example, a requestor may submit the status request from a portal presented from a web server, and the web server may invoke a web service of a backend application (directly, through an application server, or via other mechanism), which delivers the request to the status generation component in block 602.

The status generation component determines a state of processing of the case according to the applicable business process workflow (block 604). The component status generation determines a status of the processing reported from one or more workflow states (block 606). The component determines an inter-state current status from the workflow (block 608). In one embodiment, block 608 causes status determination component 412 in FIG. 4 to interrogate business process component 414 in FIG. 4 to determine a level of update completion, such as by determining the completed portions of the state transition currently being processed for the update. For example, if for completing a transition from one state to another, a workflow is waiting on ten documents from three individuals, and four documents from one individual have been received, such a status between states when the state transition cannot occur is an example of inter-state current status according to an embodiment. Such status is not available from a case repository, and an embodiment extracts information from a workflow to construct such inter-state status information in block 608.

The status generation component adds to a status report combines the workflow reported state-wise status and the inter-state status as of the time of the request of block 602 (block 610). The status generation component returns the status report, such as by transmitting a suitably formatted response (block 612). Process 600 ends thereafter. In one embodiment, the status generation component returns the status report to a sender of the web service request, such as a web server. In another embodiment, the status generation component returns the status report to an application server, which can further process or transmit the status report to the web server.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Thus, a computer implemented method, system, and computer program product are provided in the illustrative embodiments for providing a portal based case status management function. An embodiment is useful in an environment where applications are provided as services over the internet.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable storage device(s) or computer readable media having computer readable program code embodied thereon.

Any combination of one or more computer readable storage device(s) or computer readable media may be utilized. The computer readable medium may be a computer readable signal medium or a computer readable storage medium. A computer readable storage device may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage device would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage device may be any tangible device or medium that can contain, or store a program for use by or in connection with an instruction execution system, apparatus, or device.

Program code embodied on a computer readable storage device or computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to one or more processors of one or more general purpose computers, special purpose computers, or other programmable data processing apparatuses to produce a machine, such that the instructions, which execute via the one or more processors of the computers or other programmable data processing apparatuses, create means for implementing the functions/acts specified in the flowchart and/or block diagram block or blocks.

These computer program instructions may also be stored in one or more computer readable storage devices or computer readable media that can direct one or more computers, one or more other programmable data processing apparatuses, or one or more other devices to function in a particular manner, such that the instructions stored in the one or more computer readable storage devices or computer readable medium produce an article of manufacture including instructions which implement the function/act specified in the flowchart and/or block diagram block or blocks.

The computer program instructions may also be loaded onto one or more computers, one or more other programmable data processing apparatuses, or one or more other devices to cause a series of operational steps to be performed on the one or more computers, one or more other programmable data processing apparatuses, or one or more other devices to produce a computer implemented process such that the instructions which execute on the one or more computers, one or more other programmable data processing apparatuses, or one or more other devices provide processes for implementing the functions/acts specified in the flowchart and/or block diagram block or blocks.

The terminology used herein is for the purpose of describing particular embodiments only and is not intended to be limiting of the invention. As used herein, the singular forms “a”, “an” and “the” are intended to include the plural forms as well, unless the context clearly indicates otherwise. As used herein, a set includes one or more members unless the context indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

What is claimed is:

1. A method for providing a current status of an update to a data record, the method comprising:
a computer receiving, from a portal in a backend application, a request for status of a previous request to perform the update to the data record;
the computer determining a previously reported status from a previously completed processing operation on the data record in a workflow used for processing the previous request;
the computer further determining a status of a presently incomplete processing operation on the data record in the workflow used for processing the previous request;
the computer adding the previously reported status and the status of the presently incomplete processing operation to a status report, forming the current status; and
the computer transmitting a response including the current status.

2. The method of claim 1, further comprising:
the computer identifying a historic request for updating the data record;
the computer determining a second previously reported status in processing the historic request; and
the computer adding the second previously reported status with the status report.

3. The method of claim 1, wherein the data record is an employee record, and wherein the backend application is an application for managing employee records.

4. The method of claim 1, wherein the computer receiving the request comprises the computer receiving the request via a web service interface of the backend application.

5. The method of claim 4, wherein the web service interface conforms to a web service specification using Web Services Description Language (WSDL).

6. The method of claim 1, further comprising:
the computer authenticating a sender of the request for status, wherein the authenticating uses a credential different from a second credential used by the sender to login to the portal.

7. A computer program product comprising one or more computer-readable tangible storage devices and computer-readable program instructions which are stored on the one or more storage devices and when executed by one or more processors, perform the method of claim 1.

8. A computer system comprising one or more processors, one or more computer-readable memories, one or more computer-readable tangible storage devices and program instructions which are stored on the one or more storage devices for execution by the one or more processors via the one or more memories and when executed by the one or more processors perform the method of claim 1.

9. A computer program product for providing a current status of an update to a data record, the computer program product comprising:
one or more computer-readable tangible storage devices;
program instructions, stored on at least one of the one or more storage devices, to receive, from a portal in a backend application, a request for status of a previous request to perform the update to the data record;
program instructions, stored on at least one of the one or more storage devices, to determine a previously reported status from a previously completed processing operation on the data record in a workflow used for processing the previous request;
program instructions, stored on at least one of the one or more storage devices, to further determine a status of a presently incomplete processing operation on the data record in the workflow used for processing the previous request;
program instructions, stored on at least one of the one or more storage devices, to add the previously reported status and the status of the presently incomplete processing operation to a status report, forming the current status; and
program instructions, stored on at least one of the one or more storage devices, to transmit a response including the current status.

10. The computer program product of claim 9, further comprising:
program instructions, stored on at least one of the one or more storage devices, to identify a historic request for updating the data record;
program instructions, stored on at least one of the one or more storage devices, to determine a second previously reported status in processing the historic request; and
program instructions, stored on at least one of the one or more storage devices, to add the second previously reported status to the status report.

11. The computer program product of claim 9, wherein the data record is an employee record, and wherein the backend application is an application for managing employee records.

12. The computer program product of claim 9, wherein the program instructions to receive the request comprise program instructions, stored on at least one of the one or more storage devices, to receive the request via a web service interface of the backend application.

13. The computer program product of claim 13, wherein the web service interface conforms to a web service specification using Web Services Description Language (WSDL).

14. The computer program product of claim 9, further comprising:
program instructions, stored on at least one of the one or more storage devices, to authenticate a sender of the request for status, wherein the program instructions, stored on at least one of the one or more storage devices, to authenticate uses a credential different from a second credential used by the sender to login to the portal.

15. The computer program product of claim 9, wherein the program instructions are stored in the one or more computer-readable tangible storage devices in a data processing system, and wherein the program instructions are transferred over a network from a remote data processing system.

16. The computer program product of claim 9, wherein the program instructions are stored in the one or more computer-readable tangible storage devices in a server data processing system, and wherein the program instructions are downloaded over a network to a remote data processing system for use in a computer-readable tangible storage device associated with the remote data processing system.

17. A computer system for providing a current status of an update to a data record, the computer system comprising:
one or more processors, one or more computer-readable memories and one or more computer-readable tangible storage devices;
program instructions, stored on at least one of the one or more storage devices for execution by at least one of the one or more processors via at least one of the one or more memories, to receive, from a portal in a backend application, a request for status of a previous request to perform the update to the data record;
program instructions, stored on at least one of the one or more storage devices for execution by at least one of the one or more processors via at least one of the one or more memories, to determine a previously reported status from a previously completed processing operation on the data record in a workflow used for processing the previous request;
program instructions, stored on at least one of the one or more storage devices for execution by at least one of the one or more processors via at least one of the one or more memories, to further determine a status of a presently incomplete processing operation on the data record in the workflow used for processing the previous request;
program instructions, stored on at least one of the one or more storage devices for execution by at least one of the one or more processors via at least one of the one or more memories, to add the previously reported status and the status of the presently incomplete processing operation to a status report, forming the current status; and
program instructions, stored on at least one of the one or more storage devices for execution by at least one of the one or more processors via at least one of the one or more memories, to transmit a response including the current status.

18. The computer system of claim 17, further comprising:
program instructions, stored on at least one of the one or more storage devices for execution by at least one of the one or more processors via at least one of the one or more memories, to identify a historic request for updating the data record;
program instructions, stored on at least one of the one or more storage devices for execution by at least one of the one or more processors via at least one of the one or more memories, to determine a second previously reported status in processing the historic request; and
program instructions, stored on at least one of the one or more storage devices for execution by at least one of the one or more processors via at least one of the one or more memories, to add the second previously reported status with the status report.

19. The computer system of claim 17, wherein the data record is an employee record, and wherein the backend application is an application for managing employee records.

20. The computer system of claim 17, wherein the program instructions to receive the request comprise program instructions, stored on at least one of the one or more storage devices for execution by at least one of the one or more processors via at least one of the one or more memories, to receive the request via a web service interface of the backend application.
